(19) United States
(12) Patent Application Publication
(10) Pub. No.: US 2005/0223141 A1
(43) Pub. Date: Oct. 6, 2005

(54) Data flow control in a data storage system

(76) Inventors: Pak-Lung Seto, Shrewsbury, MA (US); Richard C. Beckett, Phoenix, AZ (US); Devicharan Devidas, Chandler, AZ (US)

Correspondence Address: Grossman, Tucker, Perreault & Pfleger, PLLC;c/o PortfolioIP, P.O. Box 52050, Minneapolis, MN, 55402, US

(21) Appl. No.: 10/815,271

(22) Filed: Mar. 31, 2004

(51) Int. Cl. G06F 13/14

(52) U.S. Cl. 710/57

(57) ABSTRACT

A method according to one embodiment may include receiving data in a receive buffer, and sending a hold command to a transmitting node currently sending data to hold transmission of additional data when a level of the data in the receive buffer reaches an adjustable high threshold level. Of course, many alternatives, variations, and modifications are possible without departing from this embodiment.

### FIELD

This disclosure relates to data flow control in a data storage system.

### BACKGROUND

A conventional data storage system may include one device capable of bidirectional communication with another device. One device may include a computer node having a host bus adapter (HBA). The other device may be a mass storage device. A variety of intermediate devices such as expanders, bridges, routers, and switches may also be utilized in the data storage system to facilitate coupling and communication between a plurality of HBAs and mass storage devices. The HBA and mass storage device may each function as a transmitting and receiving device in order to exchange data and/or commands with each other using one or more of a variety of communication protocols. A protocol engine having a transmitting and receiving portion may be utilized to facilitate such communication. The receiving portion of the protocol engine may include a receive buffer that accepts data from any variety of transmitting devices and provides such data to memory.

In one prior art embodiment, the receive buffer may have one fixed threshold level, e.g., a fixed high threshold level. When the total amount of data in the receive buffer exceeds the fixed high threshold level, a hold type command may be sent from the receiving device to the transmitting device instructing the transmitting device to hold transmission of additional data. In response to such a hold command, the transmitting device may send a command acknowledging such command. A certain amount of time may expire, and a certain amount of data may be received, in an interim time interval from when the receiving device sends the hold type command until an acknowledgement of such command is received by the receiving device. The fixed high threshold level of the receive buffer may be fixed at a level to allow enough remaining space in the receive buffer to accept a worst case or largest amount of data as defined by the communication protocol during this interim time interval. This may lead to wasted space in the receive buffer since the worst case amount of data received during this interim time may rarely happen in actual data storage systems.

In addition, the receiving device may issue a command to the transmitting device to start sending data again as soon as the data level in the receive buffer is less than the fixed high threshold level. However, the data accumulated in the receive buffer may then quickly exceed the fixed high threshold level causing another hold command to be sent by the receiving device. The receiving device may then issue conflicting commands to hold transmission of additional data and to send additional data as accumulated data in the receive buffer varies from a level slightly below the fixed high threshold level to the fixed high threshold level resulting in data flow inefficiencies.

### BRIEF DESCRIPTION OF THE DRAWINGS

Features and advantages of embodiments of the claimed subject matter will become apparent as the following Detailed Description proceeds, and upon reference to the Drawings, where like numerals depict like parts, and in which:

FIG. 1 is a diagram illustrating a system embodiment;

FIG. 2 is a diagram illustrating in greater detail an integrated circuit in the system embodiment of FIG. 1;

FIG. 3 is a diagram illustrating adjustable threshold levels that may be implemented in the receive buffer of FIG. 2;

FIGS. 4A-4G are diagrams of the receive buffer of FIG. 2 with varying amounts of data in the buffer relative to the threshold levels;

FIG. 5 is a flow chart of operations of an automatic threshold adjustment algorithm; and

FIG. 6 is a flow chart illustrating operations according to an embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly.

### DETAILED DESCRIPTION

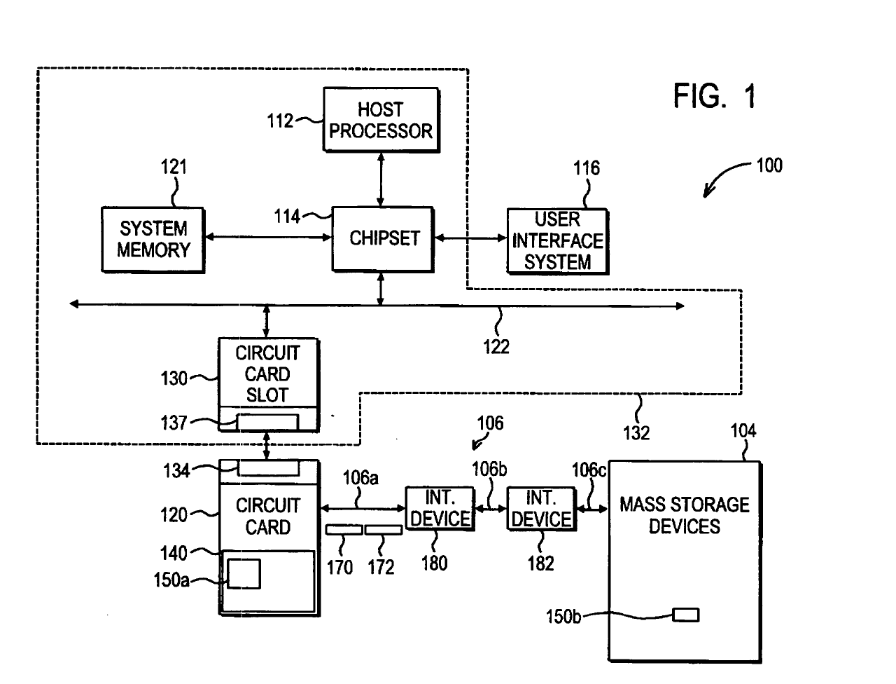

FIG. 1 illustrates a data storage system 100 consistent with an embodiment including a computer node having a host bus adapter (HBA), e.g., circuit card 120. The circuit card 120 is capable of bidirectional communication with mass storage 104 via one or more communication links 106 using one or more communication protocols. The communication links 106 may include any variety and plurality of intermediate devices 180, 182 such as expanders, bridges, routers, and switches and associated links 106a, 106b, 106c coupling the intermediate devices to the circuit card 120 and mass storage 104. Mass storage 104 may include one or more mass storage devices, e.g., one or more redundant array of independent disks (RAID) and/or peripheral devices.

Such communication between the HBA and mass storage 104 may take place by transmission of one or more frames. As used herein in any embodiment, a “frame” may comprise one or more symbols and/or values. Both the HBA 120 and mass storage 104 may act as a receiving device that receives data and/or commands from the other. Each of the HBA 120 and mass storage 104 may have protocol engine circuitry 150a, 150b to facilitate such communication. As used herein, “circuitry” may comprise, for example, singly or in any combination, hardwired circuitry, programmable circuitry, state machine circuitry, and/or firmware that stores instructions executed by programmable circuitry.

The data storage system 100 may also generally include a host processor 112, a bus 122, a user interface system 116, a chipset 114, system memory 121, a circuit card slot 130, and a circuit card 120 capable of communicating with mass storage 104. The host processor 112 may include one or more processors known in the art such as an Intel® Pentium® IV processor commercially available from the Assignee of the subject application. The bus 122 may include various bus types to transfer data and commands. For instance, the bus 122 may comply with the Peripheral Component Interconnect (PCI) Express™ Base Specification Revision 1.0, published Jul. 22, 2002, available from the PCI Special Interest Group, Portland, Oreg., U.S.A. (hereinafter referred to as a “PCI Express™ bus”). The bus 122 may alternatively comply with the PCI-X Specification Rev. 1.0a, Jul. 24, 2000, available from the aforesaid PCI Special Interest Group, Portland, Oreg., U.S.A. (hereinafter referred to as a “PCI-X bus”).

The user interface system 116 may include one or more devices for a human user to input commands and/or data and/or to monitor the system 100 such as, for example, a keyboard, pointing device, and/or video display. The chipset 114 may include a host bridge/hub system (not shown) that couples the processor 112, system memory 121, and user interface system 116 to each other and to the bus 122. Chipset 114 may include one or more integrated circuit chips, such as those selected from integrated circuit chipsets commercially available from the assignee of the subject application (e.g., graphics memory and I/O controller hub chipsets), although other integrated circuit chips may also, or alternatively be used. The processor 112, system memory 121, chipset 114, bus 122, and circuit card slot 130 may be on one circuit board 132 such as a system motherboard.

The circuit card 120 may be constructed to permit it to be inserted into the circuit card slot 130. When the circuit card 120 is properly inserted into the slot 130, connectors 134 and 137 become electrically and mechanically coupled to each other. When connectors 134 and 137 are so coupled to each other, the card 120 becomes electrically coupled to bus 122 and may exchange data and/or commands with system memory 121, host processor 112, and/or user interface system 116 via bus 122 and chipset 114.

Alternatively, without departing from this embodiment, the operative circuitry of the circuit card 120 may be included in other structures, systems, and/or devices. These other structures, systems, and/or devices may be, for example, in the motherboard 132, and coupled to the bus 122. These other structures, systems, and/or devices may also be, for example, comprised in chipset 114.

The circuit card 120 may communicate with mass storage 104 via one or more communication links 106 using one or more communication protocols. One exemplary communication protocol may include Serial Advanced Technology Attachment (S-ATA). If a S-ATA protocol is used by circuit card 120 to exchange data and/or commands with mass storage 104, it may comply or be compatible with the protocol described in “Serial ATA: High Speed Serialized AT Attachment,” Revision 1.0a, published on Jan. 7, 2003 by the Serial ATA Working Group and/or later-published versions. Another exemplary protocol may include the Serial Attached Small Computer Systems Interface (SAS) protocol. If a SAS protocol is used, it may comply or be compatible with the protocol described in “Information Technology-Serial Attached SCSI-1.1 (SAS),” Working Draft American National Standard of International Committee For Information Technology Standards (INCITS) T10 Technical Committee, Project T10/1562-D, Revision 1, published Sep. 18, 2003, by American National Standards Institute (hereinafter termed the “SAS Standard”) and/or later-published versions of the SAS Standard.

To accomplish such communication, the circuit card 120 may have protocol engine circuitry 150a. The protocol engine circuitry 150a may exchange data and commands with mass storage 104 by transmission and reception of one or more frames, e.g., frames 170, 172. A large number of frames from many different devices such as mass storage devices and HBAs may be transmitted via communication links 106. The protocol engine circuitry 150a may be included in an integrated circuit (IC) 140. As used herein, an “integrated circuit” or IC means a semiconductor device and/or microelectronic device, such as, for example, a semiconductor integrated circuit chip.

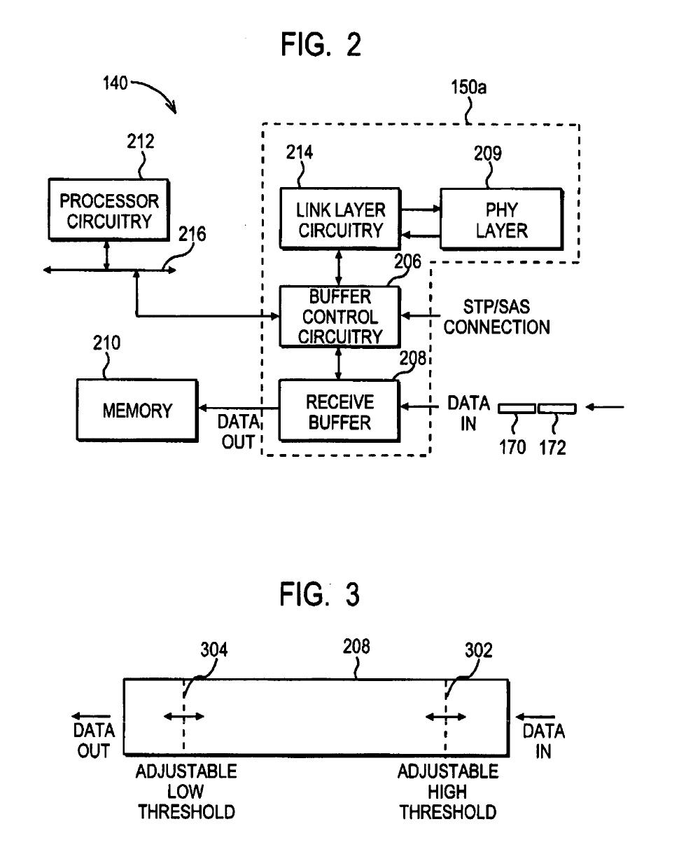

FIG. 2 illustrates portions of the integrated circuit 140 including protocol engine circuitry 150a, processor circuitry 212, processor bus 216, and memory 210. The protocol engine circuitry 150a may receive and/or transmit data and/or control signals to and from mass storage 104 via communication links 106. Such data and/or commands may be transmitted and received via frames, e.g., frames 170, 172. The frames may have a variety of formats depending, at least in part, on the communication protocol being utilized.

The protocol engine circuitry 150a may include a receive buffer 208, buffer control circuitry 206, link layer circuitry 214, and PHY layer circuitry 209. The protocol engine circuitry 150a may also include other circuitry such as data transport layer circuitry and port layer circuitry (not illustrated) to further facilitate communication using the appropriate protocol. The receive buffer 208 may be considered a mid-point holding place for data and the buffer control circuitry 206 may control storage of data in, and retrieval of data from, the receive buffer 208. In one embodiment, the receive buffer 208 may be a first-in, first-out (FIFO) buffer.

Data output from the receive buffer 208 may be provided to memory 210. The memory 210 may include one or more machine readable storage media such as random-access memory (RAM), dynamic RAM (DRAM), static RAM (SRAM) magnetic disk (e.g. floppy disk and hard drive) memory, optical disk (e.g. CD-ROM) memory, and/or any other device that can store information. The PHY layer circuitry 209 may comprise a physical PHY containing transceiver circuitry to interface to the applicable communication link. The PHY circuitry 209 may alternately and/or additionally comprise a virtual PHY to interface to another virtual PHY or to a physical PHY.

Processor circuitry 212 may include processor core circuitry that may comprise a plurality of processor cores. As used herein, a “processor core” may comprise hardwired circuitry, programmable circuitry, and/or state machine circuitry. Machine readable program instructions may be stored in any variety of machine readable media, e.g., the processor core may have a set of micro-code program instructions that may be executed by the processor circuitry 212, such that when such instructions are executed by the processor circuitry 212 it results in the processor circuitry 212 performing operations described herein. In addition, such program instructions, e.g., machine-readable firmware program instructions, may be stored in other memory locals that may be accessed and executed by the integrated circuit 140 to perform operations described herein.

Processor bus 216 may allow exchange of data and/or commands between at least the processor circuitry 212 and the buffer control circuitry 206. Additional components (not illustrated) may also be coupled to the processor bus 216. The integrated circuit 140 may also include additional components (not illustrated) such as bridge circuitry to bridge the processor bus 216 with an I/O bus. Host interface circuitry (not illustrated) may couple the I/O bus with the bus 122 of the system of FIG. 1 when the circuit card 120 is coupled to the circuit card slot 130. Data from incoming frames, e.g., frames 170, 172, via communication links 106 may be input to the receive buffer 208.

FIG. 3 illustrates the receive buffer 208 of FIG. 2. Advantageously, the receive buffer 208 may have an adjustable high threshold level 302. In addition, the receive buffer 208 may also have a low threshold level 304 and such low threshold level 304 may also be adjustable. The data input to the buffer 208 from incoming frames 170, 172 may include the entire frame. As used herein in any embodiment, a “frame” may comprise one or more symbols and/or values. For example, a S-ATA compliant frame may contain a start of frame (SOF) primitive, the frame information structure (FIS), and an end of frame (EOF) primitive. Other primitives and error checking codes may also be included in the S-ATA compliant frame. As used herein, a “primitive” may be defined as a group of one or more symbols, for example, representing control data to facilitate control of the transfer of information and/or to provide real time status information.

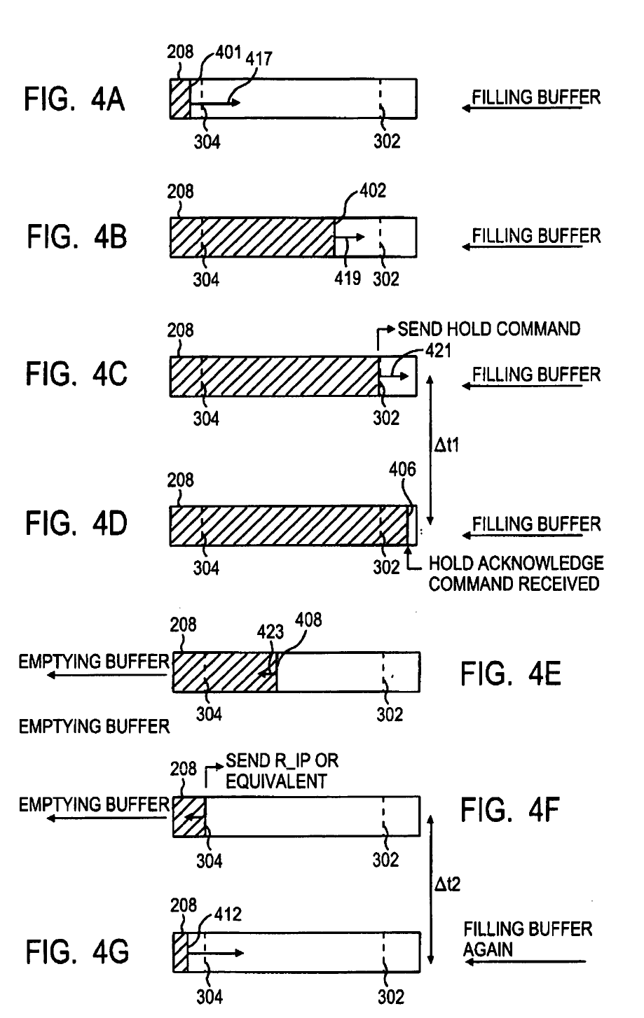

FIGS. 4A to 4G illustrate the receive buffer 208 with varying amounts of data to illustrate dynamic operation of the protocol engine circuitry 150a as the data in the receive buffer 208 is filled and emptied relative to the threshold levels 302, 304. FIG. 4A illustrates a starting position where data in the receive buffer 208 is at a level 401 less than the low threshold level 302 and the data is filling the buffer 208 as indicated by arrow 417. At this point in time, the buffer control circuitry 206 may instruct the link layer circuitry 214 to send a reception in progress type primitive to allow receipt of additional data, e.g., in S-ATA this may be a “Reception in Progress” (R_IP) primitive.

FIG. 4B illustrates the data in the receive buffer 208 has increased to a level 402 that is greater than the low threshold level 304 but still less than the adjustable high threshold level 302. Data may fill the receive buffer from the level 401 to the level 402 when the amount of data input to the receive buffer 208 exceeds the amount of data output from the receive buffer. The buffer control circuitry 206 may monitor the data level in the receive buffer 208. Since the data has not reached the adjustable high threshold level 302, the buffer control circuitry 206 may continue to instruct the link layer circuitry 214 to send a reception in progress type primitive to allow receipt of additional data. The data level 402 may continue to increase as illustrated by arrow 419.

FIG. 4C illustrates that the data level may increase until it reaches the adjustable high threshold level 302. This situation may be caused, in one instance, by lack of available data space in memory 210 to accept data from the receive buffer 208. Once the data level in the receive buffer 208 reaches the adjustable high threshold level 302, the buffer control circuitry 206 may inform the link layer circuitry 214 to send a hold type command to inform the remote node transmitting data to hold transmission of additional data. In S-ATA, such hold type command may be the HOLD primitive. The remote node transmitting data may be any variety of devices capable of transmitting data such as the intermediate devices 180, 182, mass storage 104, and/or the HBA 120.

The hold type command takes time to reach the remote transmitting node based, at least in part, on the transmission rate and the location of the transmitting node. In addition, there may be an additional delay from the time the remote node receives the hold command until the remote node responds to the hold command by sending an acknowledgement command which suspends transmission of additional data. Therefore, data may continue to accumulate in the receive buffer 208 as indicated by arrow 421. For example, in S-ATA such acknowledgement may be the HOLDA primitive. Such HOLDA primitive may be sent by the remote transmitting node as long as the HOLD primitive is received from the receiving node.

FIG. 4D illustrates data may accumulate up to a level 406 greater than the adjustable high threshold level 302 during the elapsed time interval Δt1 (between FIG. 4C and FIG. 4D) from when the receiving node issued its hold command, e.g., HOLD primitive, until reception by the receiving node of the acknowledgement command from the transmitting node, e.g., HOLDA primitive. Advantageously, the adjustable high threshold level 302 may be adjusted manually or automatically to minimize the probability that the accumulated data level 406 in such an instance will exceed the total capacity available in the receive buffer 208 during this elapsed time interval Δt1. Yet, at the same time the adjustable high threshold level 302 may be set high enough to also minimize wasted space in the receive buffer 208 between the accumulated data level 406 and the total capacity of the receive buffer.

Once the hold acknowledge command is received as illustrated in FIG. 4D, the level of data in the receive buffer 208 may start to decrease as the buffer is emptied and no additional data is received from the remote transmitting node. The data level in the buffer 208 may decrease as space becomes available in memory 210 and the buffer control circuitry 206 controls data flow out of the receive buffer 208 to memory 210.

FIG. 4E illustrates the data in the receive buffer has decreased from the level 406 illustrated in FIG. 4D to the level 408 less than the adjustable high threshold level 302 but greater than the adjustable low threshold level 304. The hold and hold acknowledge command sequence as detailed with respect to FIG. 4D is maintained even as the level of data in the receive buffer decreases below the adjustable high threshold level 302. Hence, the hold and hold acknowledge command sequence is maintained in FIG. 4E and data continues to be emptied from the buffer as indicated by arrow 423.

Eventually, the data level in the receive buffer 208 may decrease until it reaches the adjustable low threshold level 304 (FIG. 4F). At this point in time, the buffer control circuitry 206 may instruct the link layer circuitry 214 to provide a command to the remote transmitting node currently receiving a hold or equivalent type primitive command to resume transmission of additional data. For example, in S-ATA this may be the R_IP primitive. In response, the remote transmitting node may then resume sending additional data.

FIG. 4G illustrates that data that may decrease down to a level 412 less than the adjustable low threshold level 304 during the elapsed time interval Δt2 from when the receiving node issued its reception in progress type command until receipt of additional data from the transmitting node. The adjustable low threshold level 304 may be adjusted manually or automatically. Advantageously, the low threshold level reduces the probability of the receiving device sending conflicting commands too quickly to the remote transmitting node to hold transmission of additional data and to send additional data thereby avoiding data flow inefficiencies caused by such quick flip flopping of commands. This may otherwise occur in an embodiment of the prior art where the accumulated data in the receive buffer varies from a level slightly below a fixed high threshold level to the fixed high threshold level. The adjustable low threshold level may also be set to minimize the probability that all the data will be emptied from the receive buffer 208 before additional data is received from the remote transmitting node. Eventually, the data in the receive buffer 208 may rise and fall again to levels previously detailed with similar consequences as the data level reaches either the adjustable high 302 or low 304 threshold levels.

The adjustable high and low threshold levels 302, 304 may be adjusted manually or automatically depending on any variety of factors. For a manual adjustment, a user may utilize the user interface system 116 to input commands to set the adjustable high and/or low threshold levels 302, 304 at desired levels. To accomplish such a manual adjustment, a program may be written and stored in any variety of storage medium that, based upon commands entered by the user, adjusts the high and/or low threshold levels 302, 304. The buffer control circuitry 206 may then be responsive to such a program to instruct the link layer circuitry 214 to issue a hold type command when the buffer control circuitry 206 recognizes the data level in the receive buffer 208 reached the level specified by the user as the high threshold level 302.

The adjustable high and low threshold levels 302, 304 may also be adjusted automatically based on an automatic adjustment algorithm. A user may select the automatic adjustment option to allow the algorithm to set the high and/or low threshold levels 302, 304. In general, the automatic adjustment algorithm may base decisions on how to set the threshold levels 302, 304 based on any variety of factors to dynamically adjust the high and/or low level threshold levels.

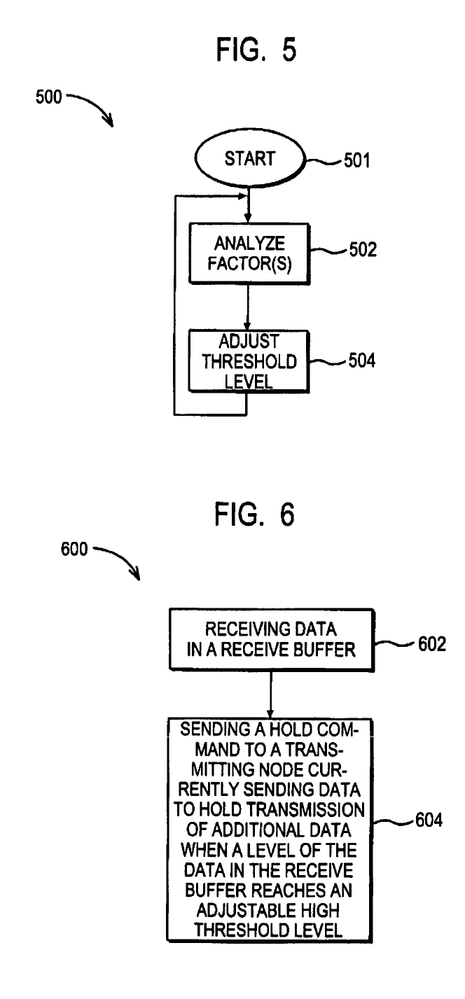

FIG. 5 illustrates operations 500 of such an automatic adjustment algorithm. A factor(s) may be analyzed in operation 502, and a particular threshold (high or low threshold level) may be adjusted in response to such a factor in operation 504. The factor(s) in operation 502 may then be continually analyzed and the particular threshold level may be dynamically updated as the factor or factors change.

The high level threshold level 302 may be dynamically adjusted based on any factor that may impact the overall latency period from the time the receiving node sends a hold type command to the transmitting node until the receiving node receives an acknowledgement command from the transmitting node, e.g., time interval Δt1 between FIGS. 4C and 4D, and, in particular, the amount of data that may received within that time period. Such factors may include, but are not limited to, actual history of such round trip delay times for particular transmitting nodes and/or actual amounts of data received during those times, transmission rates (e.g., 1.5 gigabits per second (Gbps), 3.0 Gbps, etc.) of the receiving and transmitting node, distance of the transmitting node from the receiving node, and the status of whether data is being emptied from the receive buffer 208 and at what rate.

The low threshold level 304 may also be dynamically adjusted based on any variety of factors. The low threshold level may be adjusted to a level so that the receiving device is delayed from sending a receive type command to the remote transmitting node until the adjustable low threshold level is reached. Therefore, the low threshold level may be adjusted to a level less than the adjustable high threshold level. The factors that may be considered in selecting the low threshold level may include, but not be limited to, actual history of round trip delay times for particular transmitting nodes and/or actual amounts of data received during those times, transmission rates, distance of the transmitting node from the receiving node, and the status of whether data is being emptied from the receive buffer 208 and at what rate.

FIG. 6 is a flow chart of exemplary operations 600 consistent with an embodiment. Operation 602 includes receiving data in a receive buffer. This data may include data from frames, e.g., frames 170, 172. Operation 604 may include sending a hold command to a transmitting node currently sending data to hold transmission of additional data when a level of the data in the receive buffer reaches an adjustable high threshold level. For example, see FIG. 4C illustrating a condition when the data level in the receive buffer reaches the adjustable high level threshold level 302. The buffer control circuitry 206 may sense this condition and instruct the link layer circuitry 214 to issue a hold command, e.g., a HOLD primitive when a S-ATA communication protocol is utilized.

It will be appreciated that the functionality described for all the embodiments described herein, including the automatic adjustment algorithm, may be implemented using hardware, firmware, software, or a combination thereof.

Thus, in summary, one embodiment may comprise an apparatus. The apparatus may comprise circuitry capable of receiving data in a receive buffer, and sending a hold command to a transmitting node currently sending data to hold transmission of additional data when a level of the data in the receive buffer reaches an adjustable high threshold level.

Another embodiment may comprise an article. The article may comprise circuitry comprising a receive buffer to receive data, the receive buffer having a high threshold level. The circuitry is capable of sending a hold command to a transmitting node sending data to hold transmission of additional data when a level of the data in the receive buffer reaches the high threshold level. The article may further comprise a storage medium having stored therein instructions that when executed by a machine results in the following: adjusting the high threshold level.

A system embodiment may comprise a circuit card comprising an integrated circuit. The integrated circuit may comprise circuitry capable of receiving data in a receive buffer, and sending a hold command to a transmitting node currently sending data to hold transmission of additional data when a level of the data in said receive buffer reaches an adjustable high threshold level.

Advantageously, in these embodiments, the adjustable high level threshold level 302 of the receive buffer 208 enables a system designer to tune any particular system to improve data flow control performance. For example, the adjustable high threshold level 302 may be raised compared to a prior art embodiment having a lower fixed high threshold level such that the probability of entering a hold type state, e.g., transmission of a HOLD primitive and receipt of a HOLDA primitive, is minimized and hence line utilization and efficiency is improved. For instance, the current SAS standard for Serial Advanced Technology Attachment (ATA) Tunneled Protocol (STP) flow control specifies that a fixed high threshold level should be set to allow 24 Dwords of data at 1.5 gigabits per second (Gbps) and 28 Dwords of data at 3.0 Gbps to be received during the elapsed time interval Δt1 (see FIGS. 4C and 4D) where a “Dword” may contain four bytes of data. As another example, the S-ATA standard specifies the fixed high threshold level should be set to allow at least 20 Dwords to be accepted during this time interval. In actuality, due to system particulars, a lesser amount of data may typically be received during this time interval. In some instances, only 6 to 7 Dwords may be received during this time interval. Hence, an adjustment upwards of the adjustable high threshold level may be made in such an instance.

In addition, a low level threshold level 304 may be added to the receive buffer 208. This solves the problem that a receive buffer with only a fixed high threshold level may encounter if its data level fluctuates over short time periods from a level slightly below the fixed high threshold level to the fixed high threshold level. In such a situation for the receive buffer with only a fixed high threshold level, the link layer circuitry 214 would quickly flip flop between providing hold and receive type commands resulting in reduced link efficiency. The adjustable nature of the low threshold level 302 provides additional tuning ability to a system designer.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

1. A method comprising:
receiving data in a receive buffer; and
sending a hold command to a transmitting node currently sending data to hold transmission of additional data when a level of said data in said receive buffer reaches an adjustable high threshold level.

2. The method of claim 1, wherein said adjustable high threshold is adjustable in response to a transmission rate of said additional data.

3. The method of claim 1 further comprising:
receiving a hold acknowledge command acknowledging said hold command, and wherein said adjustable high threshold level is adjustable in response to an elapsed time interval between sending of said hold command and receiving of said hold acknowledge command.

4. The method of claim 1, further comprising:
holding transmission of said additional data until said data in said receive buffer reaches a low threshold level.

5. The method of claim 4, wherein said low threshold level comprises an adjustable low threshold level.

6. An apparatus comprising:
circuitry capable of receiving data in a receive buffer, and sending a hold command to a transmitting node currently sending data to hold transmission of additional data when a level of said data in said receive buffer reaches an adjustable high threshold level.

7. The apparatus of claim 6, wherein said adjustable high threshold is adjustable in response to a transmission rate of said additional data.

8. The apparatus of claim 6, wherein said circuitry is further capable of receiving a hold acknowledge command acknowledging said hold command, and wherein said adjustable high threshold level is adjustable in response to an elapsed time interval between sending of said hold command and receiving of said hold acknowledge command.

9. The apparatus of claim 6, wherein said circuitry is further capable of holding transmission of said additional data until said data in said receive buffer reaches a low threshold level.

10. The apparatus of claim 9, wherein said low threshold level comprises an adjustable low threshold level.

11. An article comprising:
circuitry comprising a receive buffer to receive data, said receive buffer having a high threshold level, and said circuitry capable of sending a hold command to a transmitting node sending data to hold transmission of additional data when a level of said data in said receive buffer reaches said high threshold level; and
a storage medium having stored therein instructions that when executed by a machine results in the following:
adjusting said high threshold level.

12. The article of claim 11, wherein said storage medium having stored therein instructions that when executed by said machine also results in the following:
adjusting said high threshold level in response to a transmission rate of said additional data.

13. The article of claim 11, wherein said storage medium having stored therein instructions that when executed by said machine also results in the following:
adjusting said high threshold level in response to an elapsed time interval from said sending of said hold command to receipt of a hold acknowledge command from said transmitting node.

14. The article of claim 11, wherein said circuitry is further capable of maintaining said command to hold transmission of said additional data until said data in said receive buffer reaches a low threshold level.

15. The article of claim 11, wherein said storage medium having stored therein instructions that when executed by said machine also results in the following:
adjusting said low threshold level.

16. The article of claim 15, wherein said storage medium having stored therein instructions that when executed by said machine also results in the following:
adjusting said low threshold level in response to a transmission rate of said additional data.

17. A system comprising:
a circuit card comprising an integrated circuit, said integrated circuit comprising circuitry capable of receiving data in a receive buffer, and sending a hold command to a transmitting node currently sending data to hold transmission of additional data when a level of said data in said receive buffer reaches an adjustable high threshold level.

18. The system of claim 17, wherein said adjustable high threshold is adjustable in response to a transmission rate of said additional data.

19. The system of claim 17, wherein said circuitry is further capable of receiving a hold acknowledge command acknowledging said hold command, and wherein said adjustable high threshold level is adjustable in response to an elapsed time interval between sending of said hold command and receiving of said hold acknowledge command.

20. The system of claim 17, wherein said circuitry is further capable of holding transmission of said additional data until said data in said receive buffer reaches a low threshold level.

21. The system of claim 20, wherein said low threshold level comprises an adjustable low threshold level.
